(19) United States
(12) Patent Application Publication
(10) Pub. No.: US 2009/0239744 A1
(43) Pub. Date: Sep. 24, 2009

(54) HONEYCOMB STRUCTURE AND METHOD FOR MANUFACTURING HONEYCOMB STRUCTURE

(75) Inventors: Kazushige Ohno, Ibi-gun (JP); Yuki Fujita, Ibi-gun (JP)

Correspondence Address: DITTHAVONG MORI & STEINER, P.C., 918 Prince St., Alexandria, VA, 22314, US

(73) Assignee: IBIDEN CO., LTD, Ogaki-shi (JP)

(21) Appl. No.: 12/407,645

(22) Filed: Mar. 19, 2009

(30) Foreign Application Priority Data
Mar. 24, 2008 (JP) PCT/JP2008/055463

(51) Int. Cl. B01J 23/58; B32B 3/12; C04B 37/00; B01J 32/00; B01J 23/44; B01J 23/42

(52) U.S. Cl. 502/328; 428/116; 156/89.22; 502/439; 502/339; 502/325; 502/330

(57) ABSTRACT

A honeycomb structure includes a plurality of honeycomb fired bodies combined with one another. The honeycomb fired bodies include a center-portion honeycomb fired body located in a center portion in a cross section perpendicular to a longitudinal direction and a peripheral-portion honeycomb fired body located in a peripheral portion in the cross section. The center-portion honeycomb fired body has a substantially rectangular cross-sectional shape and has an area from about 2500 mm² to about 5000 mm² in the cross-section. A cross-sectional shape of the peripheral-portion honeycomb fired body is different from the cross-sectional shape of the center-portion honeycomb fired body. A cross-sectional area of the peripheral-portion honeycomb fired body perpendicular to the longitudinal direction is from about 0.9 times to about 1.3 times as large as the cross-sectional area of the center-portion honeycomb fired body.

### CROSS-REFERENCE TO RELATED APPLICATIONS

The present application claims priority under 35 U.S.C. §119 to PCT Application No. PCT/JP2008/055463 filed Mar. 24, 2008, the contents of which are incorporated herein by reference in their entirety.

### BACKGROUND OF THE INVENTION

1. Field of the Invention

The present invention relates to a honeycomb structure and a method for manufacturing a honeycomb structure.

2. Discussion of the Background

As a honeycomb catalyst in which a catalyst component is supported on a honeycomb structure for use in conversion of exhaust gases discharged from vehicles, there has been proposed a honeycomb catalyst in which a material having a high specific surface area such as active alumina and a catalyst metal such as platinum are supported on the surface of a cordierite-base honeycomb structure having an integral structure and a low thermal expansion property.

Moreover, as an example of the honeycomb catalyst of this kind, there has been known a honeycomb catalyst in which an alkaline earth metal such as Ba serving as a NOx absorbing agent, and the like is supported thereon so as to be used for NOx treatment in an atmosphere with excessive oxygen, such as an atmosphere in a lean burn engine or a diesel engine.

Here, in order to improve the conversion performance, it is necessary to increase the probability of contact between exhaust gases and a catalyst noble metal as well as the NOx absorbing agent. For this purpose, a supporting carrier needs to have a higher specific surface area, and also the noble metal needs to have a small particle size and further needs to be highly dispersed. As an example of a honeycomb structure formed by using a material having a high specific surface area, a honeycomb structure manufactured by extrusion-molding a mixture of an inorganic binder with inorganic particles and inorganic fibers has been known.

Moreover, as an example of the honeycomb structure of this kind, a honeycomb structure in which a plurality of honeycomb fired bodies are combined with one another by interposing adhesive layers has been known (for example, see WO 05/063653 A1).

The honeycomb structure disclosed in WO 05/063653 A1 is a honeycomb structure manufactured by combining a plurality of rectangular pillar-shaped honeycomb fired bodies by interposing an adhesive layer therebetween, and then cutting the combined honeycomb fired bodies into a predetermined shape.

In a cross-section perpendicular to the longitudinal direction of the honeycomb structure, the honeycomb fired bodies each having a rectangular cross sectional shape are located in the center portion, and the honeycomb fired bodies each having a cross-sectional area smaller than that of the honeycomb fired body in the center portion are located in the peripheral portion.

The contents of WO 05/063653 A1 are incorporated herein by reference in their entirety.

### SUMMARY OF THE INVENTION

According to one aspect of the present invention, a honeycomb structure includes a plurality of honeycomb fired bodies combined with one another by interposing an adhesive layer therebetween. Each of the honeycomb fired bodies has partition walls extending along a longitudinal direction of the honeycomb structure to define through holes and includes inorganic particles and an inorganic binder. The honeycomb fired bodies include a center-portion honeycomb fired body and a peripheral-portion honeycomb fired body. The center-portion honeycomb fired body is located in a center portion in a cross section perpendicular to the longitudinal direction. The center-portion honeycomb fired body has a substantially rectangular cross-sectional shape perpendicular to the longitudinal direction and has an area from about 2500 mm² to about 5000 mm² in the cross-section. The peripheral-portion honeycomb fired body is located in a peripheral portion in the cross section. A cross-sectional shape of the peripheral-portion honeycomb fired body perpendicular to the longitudinal direction is different from the cross-sectional shape of the center-portion honeycomb fired body. A cross-sectional area of the peripheral-portion honeycomb fired body perpendicular to the longitudinal direction is from about 0.9 times to about 1.3 times as large as the cross-sectional area of the center-portion honeycomb fired body.

According to another aspect of the present invention, a method for manufacturing a honeycomb structure includes extrusion-molding a raw material composition containing inorganic particles and an inorganic binder to produce a center-portion honeycomb molded body to be a center-portion honeycomb fired body and a peripheral-portion honeycomb molded body to be a peripheral-portion honeycomb fired body. The center-portion honeycomb molded body has substantially a same shape as the center-portion honeycomb fired body. Each of the center-portion and the peripheral-portion honeycomb fired bodies has partition walls extending along a longitudinal direction of the honeycomb structure to define through holes. The center-portion honeycomb molded body and the peripheral-portion honeycomb molded body are heated in a degreasing furnace to remove organic components contained in the center-portion honeycomb molded body and the peripheral-portion honeycomb molded body and to degrease the center-portion honeycomb molded body and the peripheral-portion honeycomb molded body. The degreased center-portion honeycomb molded body and the degreased peripheral-portion honeycomb molded body are fired to produce the center-portion honeycomb fired body and the peripheral-portion honeycomb fired body. The center-portion honeycomb fired body has a substantially rectangular cross-sectional shape perpendicular to the longitudinal direction. The center-portion honeycomb fired body has an area from about 2500 mm² to about 5000 mm² in the cross-section. A cross-sectional shape of the peripheral-portion honeycomb fired body perpendicular to the longitudinal direction is different from a cross-sectional shape of the center-portion honeycomb fired body perpendicular to the longitudinal direction. A cross-sectional area of the peripheral-portion honeycomb fired body perpendicular to the longitudinal direction is from about 0.9 times to about 1.3 times as large as a cross-sectional area of the center-portion honeycomb fired body perpendicular to the longitudinal direction. A predetermined number of honeycomb fired bodies are combined by interposing an adhesive layer therebetween so that the peripheral-portion honeycomb fired bodies are located around the center-portion honeycomb fired body to produce a ceramic block.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a perspective view schematically showing a honeycomb structure according to the first embodiment of the present invention.

FIG. 2 is a perspective view schematically showing a center-portion honeycomb fired body in the honeycomb structure according to the first embodiment of the present invention.

FIG. 3 is a perspective view schematically showing a peripheral-portion honeycomb fired body in the honeycomb structure according to the first embodiment of the present invention.

FIG. 4 is an A-A line cross-sectional view of the honeycomb structure shown in FIG. 1.

FIG. 5 is a cross-sectional view of a conventional honeycomb structure manufactured in Comparative Example 4.

FIG. 6 is a cross-sectional view of a honeycomb structure according to the second embodiment of the present invention.

FIGS. 7A and 7B are cross-sectional views for describing another example of a method for manufacturing a honeycomb structure according to an embodiment of the present invention.

FIG. 8 is a cross-sectional view of a honeycomb structure according to another embodiment of the present invention.

### DESCRIPTION OF THE EMBODIMENTS

Embodiments will now be described with reference to the accompanying drawings, wherein like reference numerals designate corresponding or identical elements throughout the various drawings.

A honeycomb structure according to an embodiment of the present invention includes a plurality of pillar-shaped honeycomb fired bodies combined with one another by interposing an adhesive layer therebetween, each of the honeycomb fired bodies having a large number of through holes, which are longitudinally formed in parallel with one another and divided by a partition wall, wherein

the honeycomb fired bodies include inorganic particles and an inorganic binder,

the honeycomb fired bodies include a center-portion honeycomb fired body located in a center portion and a peripheral-portion honeycomb fired body located in a peripheral portion in a cross section perpendicular to the longitudinal direction,

the center-portion honeycomb fired body has a substantially square cross-sectional shape perpendicular to the longitudinal direction of the honeycomb structure,

the center-portion honeycomb fired body has an area of at least about 2500 mm² and at most about 5000 mm² in the cross-section,

a cross-sectional shape perpendicular to the longitudinal direction of the peripheral-portion honeycomb fired body is different from a cross-sectional shape perpendicular to the longitudinal direction of the center-portion honeycomb fired body, and

a cross-sectional area perpendicular to the longitudinal direction of the peripheral-portion honeycomb fired body is at least about 0.9 times and at most about 1.3 times as large as a cross-sectional area perpendicular to the longitudinal direction of the center-portion honeycomb fired body.

In the embodiment of the present invention, the center-portion honeycomb fired body refers to a honeycomb fired body which does not constitute a peripheral side surface of the honeycomb structure in a cross section perpendicular to the longitudinal direction of the honeycomb structure.

The honeycomb structure according to the embodiment of the present invention contains inorganic particles and an inorganic binder. By containing inorganic particles, it is easier to provide a honeycomb structure having a high specific surface, which is allowed to be preferably used as a honeycomb catalyst having a catalyst supported thereon.

The center-portion honeycomb fired body has a cross-sectional area of at least about 2500 mm² and at most about 5000 mm² in the cross section perpendicular to the longitudinal direction. When the cross sectional area is about 2500 mm² or more, the honeycomb fired body is not too small. Therefore, it is hardly required to manufacture a honeycomb structure by combining a large number of the honeycomb fired bodies. In this case, the relative ratio of the adhesive layer is less likely to be increased, and a heat capacity of the honeycomb structure is less likely to be high.

On the other hand, a honeycomb fired body having the cross-sectional area of about 5000 mm² or less is less likely to be damaged by thermal shock.

In the honeycomb structure according to the embodiment of the present invention, among the plurality of honeycomb fired bodies combined with one another by interposing an adhesive layer therebetween, the cross-sectional area perpendicular to the longitudinal direction of the peripheral-portion honeycomb fired bodies is at least about 0.9 times and at most about 1.3 times as large as the cross-sectional area perpendicular to the longitudinal direction of the center-portion honeycomb fired body. Therefore, since no honeycomb fired bodies having an extremely small cross-sectional area are located in the peripheral portion of the honeycomb structure and thus the relative ratio of the adhesive layer tends to be small, the heat capacity of the honeycomb fired body tends to be low.

As a result, the temperature of the honeycomb structure increases easily so that the catalyst is more likely to fully exert the conversion function.

When the cross-sectional area of the peripheral-portion honeycomb fired body is about 0.9 times or more that of the center-portion honeycomb fired body, the ratio of the adhesive layer is less likely to be large in the peripheral portion of the honeycomb structure.

On the other hand, when the cross sectional area of the peripheral-portion honeycomb fired body is about 1.3 times or less that of the center-portion honeycomb fired body, a crack due to thermal stress is less likely to occur in the honeycomb fired body.

In the honeycomb structure according to the embodiment of the present invention, it is desirable that a cross section perpendicular to the longitudinal direction of the honeycomb structure includes a peripheral portion forming a peripheral side surface of the honeycomb structure and a center portion having a substantially rectangular cross-sectional shape located at the inner side of the peripheral portion,

the peripheral portion includes a plurality of the peripheral-portion honeycomb fired bodies combined with one another by interposing the adhesive layer therebetween,

the center portion includes a single piece of the center-portion honeycomb fired body, or a plurality of the center-portion honeycomb fired bodies combined with one another by interposing the adhesive layer therebetween,

a cross section perpendicular to the longitudinal direction of the honeycomb structure includes at least one adhesive layer formed in a direction extending from a corner point of the center portion to the peripheral side surface of the honeycomb structure, among the adhesive layers in the peripheral portion, and

the adhesive layer extending from a corner point of the center portion to the peripheral side surface of the honeycomb structure forms an angle of at least about 40° and at most about 50° with at least one adhesive layer formed in a direction extending from a point other than the corner points of the center portion to the peripheral side surface of the honeycomb structure.

Hereinafter, in the present specification, an adhesive layer formed in a direction extending from a corner point of the center portion to the peripheral side surface of the honeycomb structure is also referred to as “first peripheral-portion adhesive layer”, and an adhesive layer formed in a direction extending from a point other than the corner points of the center portion to the peripheral side surface of the honeycomb structure is also referred to as “second peripheral-portion adhesive layer”, among the adhesive layers in the peripheral portion.

Further, the angle formed by the first peripheral-portion adhesive layer and the second peripheral-portion adhesive layer refers to an angle formed by a straight line passing in the first peripheral-portion adhesive layer and a straight line passing in the second peripheral-portion adhesive layer.

In the embodiment of the present invention, the center portion in a cross section perpendicular to the longitudinal direction of the honeycomb structure refers to an area occupied by the center portion honeycomb fired body, the adhesive layers combining the center-portion honeycomb fired bodies with one another, and the adhesive layers combining the center portion honeycomb fired body with the peripheral-portion honeycomb fired body. Moreover, the peripheral portion in the cross section perpendicular to the longitudinal direction of the honeycomb structure refers to an area occupied by the peripheral-portion honeycomb fired bodies and the adhesive layers combining the peripheral-portion honeycomb fired bodies with one another.

The honeycomb structure according to the embodiment of the present invention includes the center portion and the peripheral portion. In the peripheral portion located outside the center portion, a plurality of the peripheral-portion honeycomb fired bodies forming a part of the peripheral side surface of the honeycomb structure are combined with one another by interposing the adhesive layer therebetween.

In the cross section perpendicular to the longitudinal direction of the honeycomb structure, an angle formed by at least one of the adhesive layers (first peripheral-portion adhesive layer) extending from a corner point of the center portion to the peripheral side surface of the honeycomb structure and at least one of the adhesive layers (second peripheral-portion adhesive layer) extending from a point other than the corner points to the peripheral side surface of the honeycomb structure out of the adhesive layers existing between the peripheral-portion honeycomb fired bodies, is desirably at least about 40° and at most about 50°.

Therefore, damages in the honeycomb structure due to compression stress applied from the peripheral surface are more likely to be prevented from occurring.

On the other hand, in the honeycomb structure disclosed in WO 05/063653 A1, adhesive layers are formed in a lattice pattern. Thus, although the honeycomb structure has high strength against compression stress applied in a specific direction (direction parallel to the adhesive layer) from the peripheral surface, it tends to have low strength against compression stress applied in other directions, for example, a direction forming an angle of 45° with the adhesive layer, and as a result damages are more likely to occur in the honeycomb structure.

It is desirable that the honeycomb structure according to the embodiment of the present invention includes a plurality of the center-portion honeycomb fired bodies and a plurality of the peripheral-portion honeycomb fired bodies,

wherein

the cross-sectional surface areas of the plurality of the center-portion honeycomb fired bodies are substantially the same with each other, and

the cross-sectional surface areas of the plurality of the peripheral-portion honeycomb fired bodies are substantially the same with each other.

The above-mentioned structure makes it easier to manufacture a honeycomb structure.

In the honeycomb structure according to the embodiment of the present invention, the cross-sectional shape perpendicular to the longitudinal direction of the peripheral-portion honeycomb fired body is desirably formed into a shape surrounded by three line segments and one curved line, and

two angles made by the two line segments out of the three line segments are desirably a substantially right angle and an obtuse angle.

It is desirable that the honeycomb structure according to the embodiment of the present invention further includes an inorganic fiber.

In the honeycomb structure according to the embodiment of the present invention, the inorganic fiber desirably includes at least one of alumina, silica, silicon carbide, silica-alumina, glass, potassium titanate and aluminum borate.

When the inorganic fiber is included, the strength of the honeycomb structure is more likely to be further improved.

In the honeycomb structure according to the embodiment of the present invention, a catalyst is desirably supported on the partition wall. Further, in the honeycomb structure according to the embodiment of the present invention, the catalyst desirably includes at least one of a noble metal, an alkali metal and an alkaline earth metal.

Moreover, in the honeycomb structure according to the embodiment of the present invention, the noble metal desirably includes at least one of platinum, palladium and rhodium.

Moreover, in the honeycomb structure according to the embodiment of the present invention, the alkali metal desirably includes at least one of potassium and sodium.

Moreover, in the honeycomb structure according to the embodiment of the present invention, the alkaline earth metal desirably includes at least one of magnesium, barium and calcium.

In the honeycomb structure according to the embodiment of the present invention, the inorganic binder desirably includes at least one of alumina sol, silica sol, titania sol, water glass, sepiolite and attapulgite.

Hereinafter, in the present specification, the cross section perpendicular to the longitudinal direction of the honeycomb structure, the cross section perpendicular to the longitudinal direction of the honeycomb fired body, and the cross section perpendicular to the longitudinal direction of the honeycomb molded body may be simply referred to as the cross section of the honeycomb structure, the cross section of the honeycomb fired body, and the cross section of the honeycomb molded body, respectively.

Moreover, in the present specification, the cross-sectional area perpendicular to the longitudinal direction of the honeycomb structure, the cross-sectional area perpendicular to the longitudinal direction of the honeycomb fired body, and the cross-sectional area perpendicular to the longitudinal direction of the honeycomb molded body may be simply referred to as the cross-sectional area of the honeycomb structure, the cross-sectional area of the honeycomb fired body, and the cross-sectional area of the honeycomb molded body, respectively.

As described above, the honeycomb fired bodies used for forming the honeycomb structure according to the embodiment of the present invention are distinguished as the center-portion honeycomb fired bodies and the peripheral-portion honeycomb fired bodies. However, in the present specification, when it is not necessary to distinguish the two kinds of the honeycomb fired bodies, each of the honeycomb fired bodies is simply described as the honeycomb fired body.

Upon using a honeycomb structure as a honeycomb catalyst, high-temperature exhaust gases discharged from an internal combustion engine flow into through holes of the honeycomb structure. At this time, since the exhaust gases tend to flow in the through holes of the honeycomb fired bodies located in the center portion, much heat is applied to the honeycomb fired bodies located in the center portion, and thus the temperature of those honeycomb fired bodies is more likely to increase than the honeycomb fired bodies located in the peripheral portion.

For this reason, temperature distribution is more likely to occur in the diameter direction of the honeycomb structure.

In the case where the temperature distribution of this kind occurs, stress is more likely to be applied to the peripheral face of the honeycomb structure, and thus the honeycomb structure may be damaged.

Further, since the catalyst supported on the honeycomb structure has characteristics of exerting its gas-conversion function when activated under a high temperature condition, the catalyst tends to be unable to fully exert the function when the temperature of the honeycomb structure is low, for example, at the time when the engine is started.

Therefore, desirably, the temperature of the honeycomb structure is easily increased.

However, in a honeycomb structure in which a plurality of honeycomb fired bodies are combined with one another by interposing an adhesive layer therebetween (hereinafter, also referred to as aggregated honeycomb structure), since the heat capacity of the adhesive layer tends to be usually higher than that of the honeycomb fired body, the presence of the adhesive layers prevents the temperature from rising in the honeycomb structure.

According to a honeycomb structure particularly of the kind disclosed in WO 05/063653 A1, honeycomb fired bodies having a cross-sectional area smaller than that of the center-portion honeycomb fired bodies are located in the peripheral portion. The presence of those honeycomb fired bodies having a smaller cross-sectional area causes a problem that the ratio of the adhesive layer is more likely to be increased and as a result the heat capacity of the honeycomb structure is more likely to be increased.

In the embodiment of the present invention, a honeycomb structure is less likely to be damaged by the force applied to a radial direction and is more likely to have a low heat capacity.

### First Embodiment

Referring to the drawings, the following description will discuss a first embodiment of the honeycomb structure according to the embodiments of the present invention.

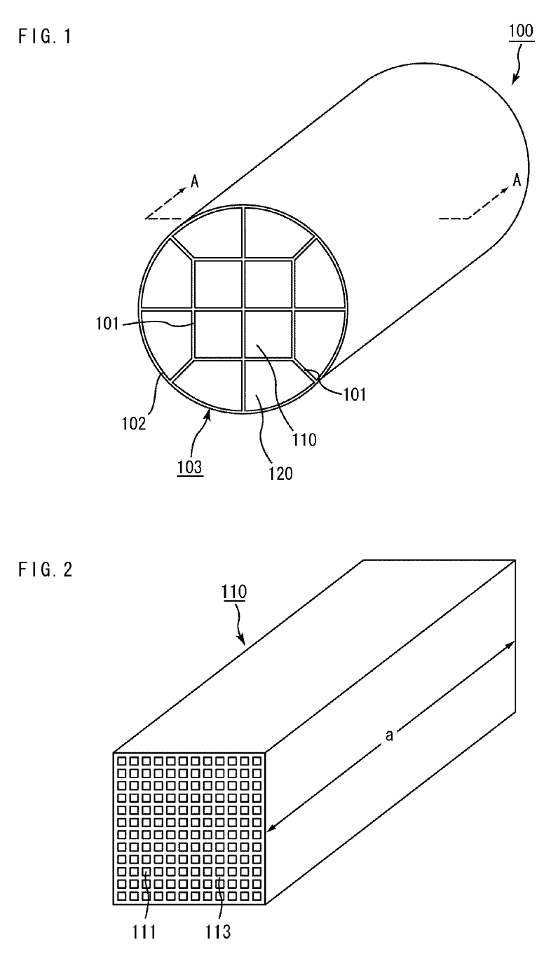

FIG. 1 is a perspective view schematically showing a honeycomb structure according to the first embodiment. FIG. 2 is a perspective view schematically showing a center-portion honeycomb fired body in the honeycomb structure according to the first embodiment.

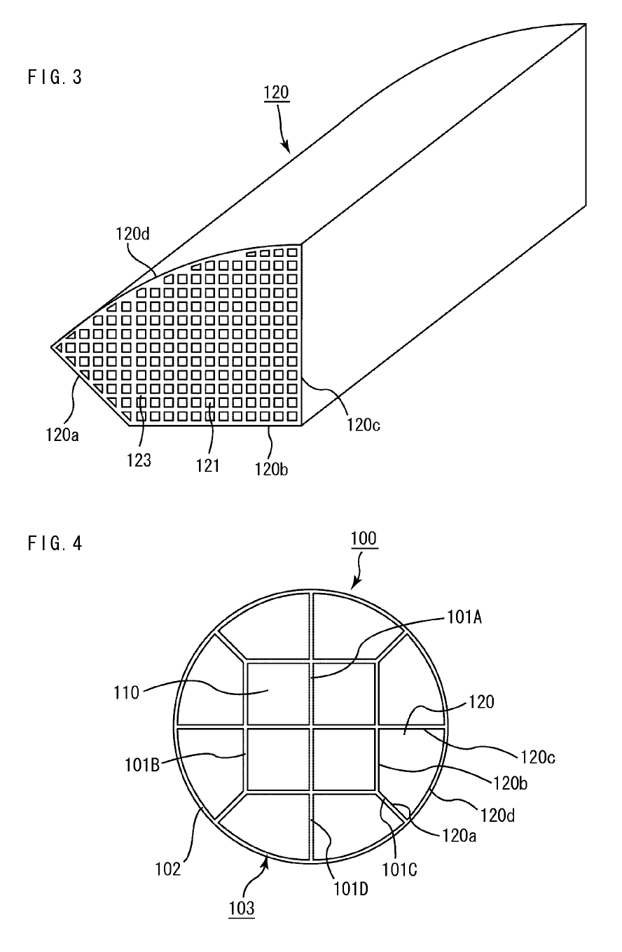

FIG. 3 is a perspective view schematically showing a peripheral-portion honeycomb fired body according to the first embodiment. FIG. 4 is an A-A line cross-sectional view of the honeycomb structure shown in FIG. 1.

In a honeycomb structure 100 shown in FIG. 1 and FIG. 4, a plurality of center-portion honeycomb fired bodies 110 having a shape shown in FIG. 2 and a plurality of peripheral-portion honeycomb fired bodies 120 having a shape shown in FIG. 3 are combined with one another, with an adhesive layer 101 (101A, 101B, 101C, 101D) interposed therebetween, to form a ceramic block 103. A coat layer 102 is further formed on the periphery of the ceramic block 103.

The shape of the cross section of each of the center-portion honeycomb fired bodies 110 is a substantially square shape.

The cross section of each of the peripheral-portion honeycomb fired bodies 120 is formed into a shape that is surrounded by three line segments 120a, 120b and 120c and an arc 120d. The two angles made by two line segments out of these three line segments (an angle formed by the line segment 120b and the line segment 120c and an angle formed by the line segment 120a and the line segment 120b) are about 90° and about 135°, respectively.

In the center-portion honeycomb fired body 110 shown in FIG. 2, a large number of through holes 111 are placed in parallel with one another by interposing a partition wall 113 therebetween, in a longitudinal direction (direction shown by an arrow a in FIG. 2).

A catalyst for converting exhaust gases is supported on the partition wall 113.

Since the through holes 111 allow a fluid such as exhaust gases to flow therethrough, and the catalyst for converting exhaust gases is supported on the partition wall 113, toxic components contained in the exhaust gases are converted by the action of the catalyst.

In the same manner as in the center-portion honeycomb fired body 110, the peripheral-portion honeycomb fired body 120 shown in FIG. 3 has a structure in which a large number of through holes 121 are longitudinally placed in parallel with one another by interposing a partition wall 123 therebetween.

A catalyst for converting exhaust gases is also supported on the partition wall 123, and thus exhaust gas passing through the through hole 121 is converted by the action of the catalyst.

That is, although the outer shape of the peripheral-portion honeycomb fired body 120 is different from that of the center-portion honeycomb fired body 110, the peripheral-portion honeycomb fired body 120 has the same functions as those of the center-portion honeycomb fired body 110.

As shown in FIG. 1 and FIG. 4, in the honeycomb structure 100, four pieces of the center-portion honeycomb fired bodies 110 are located in the center portion of the cross section of the honeycomb structure 100, and eight pieces of the peripheral-portion honeycomb fired bodies 120 are located on the periphery of the four pieces of center-portion honeycomb fired bodies. These honeycomb fired bodies are combined with one another with an adhesive layer 101 interposed therebetween so that the cross section of the honeycomb structure 100 (ceramic block 103) is formed into a substantially round shape.

Further, as shown in FIG. 4, the four pieces of center-portion honeycomb fired bodies 110 combined by interposing the adhesive layer 101A form the center portion in a cross section of the honeycomb structure 100, and the eight pieces of peripheral-portion honeycomb fired bodies 120 combined by interposing the adhesive layers 101C and 101D form the peripheral portion in a cross section of the honeycomb structure 100.

In the cross section (see FIG. 4) of the honeycomb structure 100 having the structure of the kind as mentioned above, the area occupied by the four pieces of the center-portion honeycomb fired bodies 110, the adhesive layers 101A combining the center-portion honeycomb fired bodies 110 with one another, and the adhesive layers 101B combining the center-portion honeycomb fired body 110 with the peripheral-portion honeycomb fired body 120 corresponds to the center portion. Also, the area occupied by the eight pieces of the peripheral-portion honeycomb fired bodies 120, and the adhesive layers 101C and 101D combining the peripheral-portion honeycomb fired bodies 120 with one another corresponds to the peripheral portion.

It is to be noted that the cross-sectional surface areas of the respective plurality of the center-portion honeycomb fired bodies 110 that form the honeycomb structure 100 are substantially the same with each other, and also the cross-sectional surface areas of the respective plurality of the peripheral-portion honeycomb fired bodies 120 that form the honeycomb structure 100 are substantially the same with each other.

In the cross section of the honeycomb structure 100, out of the peripheral-portion adhesive layers 101C and 101D, the adhesive layer 101C (first peripheral-portion adhesive layer) formed in a direction extending from a corner point of the center portion to the peripheral side surface of the honeycomb structure 100, and the adhesive layer 101D (second peripheral-portion adhesive layer) formed in a direction extending from a point other than the corner points of the center portion to the peripheral side surface of the honeycomb structure form an angle of about 45°.

When the first peripheral-portion adhesive layer and the second peripheral-portion adhesive layer form an angle of about 45° as mentioned above, damages in the honeycomb structure is more likely to be prevented from occurring.

Moreover, in the honeycomb structure 100, a Y-shape is formed by the first peripheral-portion adhesive layer 101C and the two adhesive layers 101B each combining the center portion honeycomb fired body 110 with the peripheral-portion honeycomb fired body 120 at the corner point of the above-mentioned center portion.

When the cross section of the honeycomb structure includes a part in which the adhesive layers form a Y-shape as mentioned above, the structure is appropriate for absorbing the stress in the honeycomb structure. As a result, damages in the honeycomb structure are more likely to be prevented from occurring.

Further, in the cross section of the honeycomb structure 100, the second peripheral-portion adhesive layer 101D and the adhesive layer 101A combining the center-portion honeycomb fired bodies 110 with one another form a straight line configuration.

Those adhesive layers are more likely to function as so called a beam to improve the strength of the honeycomb structure.

Moreover, in the honeycomb structure 100, the cross-sectional area of the peripheral-honeycomb fired body 120 is at least about 0.9 times and at most about 1.3 times as large as that of the center-portion honeycomb fired body 110.

Therefore, since there is no honeycomb fired bodies having an extremely small cross-sectional area in the peripheral portion of the honeycomb structure 100 and the relative ratio of the adhesive layer tends to be small, the heat capacity of the honeycomb structure tends to be low.

As a result, the temperature of the honeycomb structure increases easily, and thus the conversion action of the catalyst is more likely to be fully exerted.

Moreover, in the honeycomb structure 100, the cross-sectional area of the center-portion honeycomb fired body 110 is at least about 2500 mm² and at most about 5000 mm².

When the cross-sectional area is about 2500 mm² or more, since the honeycomb fired bodies are not too small, it is less likely to be required to combine a large number of the honeycomb fired bodies to manufacture the honeycomb structure. As a result, the relative ratio of the adhesive layer is less likely to be increased, and the heat capacity of the honeycomb structure is less likely to be increased.

The honeycomb fired bodies 110 and 120 include inorganic particles and an inorganic binder.

Since the specific surface is increased by the inclusion of the inorganic particles, the honeycomb fired bodies 110 and 120 are more likely to be preferably used as a catalyst carrier.

Particles including of alumina, silica, zirconia, titania, ceria, mullite, zeolite and the like may be exemplified as the inorganic particles. Those particles may be used alone, or two or more kinds of those particles may be used in combination.

As the inorganic binder, an inorganic sol, a clay binder, or the like may be used. Examples of the inorganic sol include alumina sol, silica sol, titania sol, water glass, and the like. Examples of the clay binder include polychain-structure clays such as white clay, kaolin, montmorillonite, sepiolite, and attapulgite. Those inorganic binders may be used alone, or two or more kinds of the inorganic binders may be used in combination.

Preferable examples among the above are at least one of alumina sol, silica sol, titania sol, water glass, sepiolite, and attapulgite.

The inorganic sols, the clay binders, and the like contain moisture, and thus the inorganic binder is prepared by using the inorganic components that is remained after heating the inorganic sols, the clay binders, and the like to remove moisture therein.

The honeycomb fired bodies 110 and 120 may further include inorganic fibers.

The strength of the honeycomb fired bodies is improved by including the inorganic fibers.

Preferable examples of the inorganic fibers include inorganic fibers including alumina, silica, silicon carbide, silica-alumina, glass, aluminum borate whisker, potassium titanate, or the like. The inorganic fibers may be used alone, or two or more kinds of the inorganic fibers may be used in combination. Aluminum borate whisker is more preferable among the above inorganic fibers.

It is to be noted that, the inorganic fibers refer to inorganic fibers having an average aspect ratio (length/diameter) of more than about five in this specification. Moreover, a preferable average aspect ratio of the inorganic fiber is at least about 10 and at most about 1000.

In the present specification, the inorganic fibers include a whisker.

Preferably, the above-mentioned adhesive layer is preferably formed by using, as raw materials, an adhesive paste containing the previously described inorganic particles, the inorganic fibers and/or whisker, the inorganic binder, and an organic binder.

The organic binder is not particularly limited, and examples thereof include polyvinyl alcohol, methylcellulose, ethylcellulose, carboxymethylcellulose, and the like.

The catalyst (metal catalyst) to be supported on the honeycomb structure of the present embodiment is not particularly limited, and examples thereof include a noble metal, an alkali metal, an alkaline earth metal, and the like.

The catalyst may be used alone, or two or more kinds of them may be used in combination.

Examples of the noble metal include platinum, palladium, rhodium, and the like. Examples of the alkali metal include potassium, sodium, and the like. Examples of the alkaline earth metal include barium, calcium, magnesium, and the like.

Application of the above-mentioned honeycomb structure on which the catalyst is supported (honeycomb catalyst) is not particularly limited, and may be used as so called a three-way catalyst or NOx-converting catalyst for conversion of exhaust gases from vehicles.

Hereinafter, the method for manufacturing the honeycomb structure of the present embodiment will be described.

A raw material composition is firstly prepared, and then the raw material composition is extrusion-molded so as to perform molding for manufacturing the honeycomb molded body having a predetermined shape.

An example of the raw material composition is a composition that includes the inorganic particles, and the inorganic fibers, and/or whisker as main ingredients, and further optionally includes the inorganic binder, the organic binder, a plasticizer, a lubricant, a dispersion medium, and a molding auxiliary so as to achieve an appropriate moldability.

In order to manufacture a honeycomb molded body having a cross section surrounded by three line segments and one arc, in which the two line segments out of the three line segments form two angles of about 90° and about 135°, or a honeycomb molded body having a substantially rectangular cross section, a die for extrusion molding is appropriately used depending on the shapes of the aforementioned honeycomb molded bodies.

Then, the manufactured honeycomb molded body is cut in a predetermined length, and drying is performed by using a microwave drying apparatus, a hot-air drying apparatus, a dielectric drying apparatus, a reduced-pressure drying apparatus, a vacuum drying apparatus, a freeze drying apparatus, or the like.

Next, degreasing is performed by heating the honeycomb molded body in a degreasing furnace to remove organic components in the honeycomb molded body.

Conditions for degreasing are not particularly limited, and may appropriately be selected depending on the kinds and amount of the organic components contained in the honeycomb molded body. Preferably, the degreasing is performed at a temperature of about 400° C. for about two hours.

Next, firing is performed to fire the degreased honeycomb molded body.

Conditions for firing are not particularly limited. Preferably, firing is performed at a temperature of at least about 500° C. and at most about 1200° C., and more preferably at a temperature in a range of about 600° C. to about 1000° C.

By performing the above-mentioned procedures, the center-portion honeycomb fired bodies and the peripheral-portion honeycomb fired bodies can be manufactured.

Next, combining for manufacturing a ceramic block is performed by applying an adhesive paste on a predetermined side surface of each of the center-portion honeycomb fired body and the peripheral-portion honeycomb fired body so as to form an adhesive paste layer, placing another honeycomb fired body on the thus formed adhesive paste layer, and sequentially repeating the formation of an adhesive paste layer and the placement of another honeycomb fired body, thereby manufacturing a ceramic block in which a predetermined number of honeycomb fired bodies are combined with one another.

The adhesive paste to be used here may be the above-mentioned adhesive paste.

Next, a coat layer is formed by applying a coating material paste on the periphery of the ceramic block that has been formed in a cylindrical shape, and then drying and solidifying the coating material paste.

The coating material paste to be used here may be a paste that is similar to the above-mentioned adhesive paste. It is also possible to use a paste having a different composition from the adhesive paste as the coating material paste.

The coat layer is not necessarily provided, and may be formed depending on the needs.

Through the above-mentioned procedures, the honeycomb structure according to the present embodiment can be manufactured.

The effects of the honeycomb structure of the present embodiment will be listed below.

(1) In the honeycomb structure according to the present embodiment, the first peripheral-portion adhesive layer and the second peripheral-portion adhesive layer form an angle of about 45°. Therefore, damages due to stress applied in various directions in the peripheral surface of the honeycomb structure is more likely to be prevented from occurring in the honeycomb structure.

(2) In the honeycomb structure according to the present embodiment, the cross-sectional area of a cross section perpendicular to the longitudinal direction of the center-portion honeycomb fired body is at least about 2500 mm² and at most about 5000 mm². Therefore, the ratio of the adhesive layer is more likely to be relatively small, and thus the honeycomb structured body is more likely to have a low heat capacity.

Further, the honeycomb structure thus obtained is not easily damaged by thermal shock.

(3) In the honeycomb structure according to the present embodiment, the cross-sectional area of the peripheral-portion honeycomb structure is at least about 0.9 times and at most about 1.3 times as large as the cross-sectional area of the center-portion honeycomb structure. Therefore, a honeycomb fired body having an extremely small cross-sectional area is not present in the peripheral portion of the honeycomb structure, and thus the ratio of the adhesive layer is more likely to be relatively small and the heat capacity of the honeycomb structure is more likely to be reduced.

Therefore, the temperature of the honeycomb structure is easily increased, and the conversion effect of the catalyst such as a NOx conversion catalyst is more likely to be fully exerted.

(4) In the honeycomb structure according to the present embodiment, the cross-sectional surface areas of the plurality of the center-portion honeycomb fired bodies are substantially the same with each other, and the cross-sectional surface areas of the plurality of the peripheral-portion honeycomb fired bodies are substantially the same with each other. Accordingly, the honeycomb structure can be easily manufactured.

(5) The honeycomb structure according to the present embodiment contains inorganic particles and an inorganic binder. By containing inorganic particles, it becomes easier to provide a honeycomb structure having a high specific surface, which is more likely to be preferably used as a honeycomb catalyst having a catalyst supported thereon.

(6) The honeycomb structure according to the present embodiment contains inorganic fibers, and due to the inorganic fibers contained therein, the honeycomb structure is allowed to have high strength.

### EXAMPLES

### Example 1

The following description will discuss examples that more specifically disclosing the first embodiment of the present invention are shown below. However, the honeycomb structure of the present invention should not be construed to be limited to those examples.

(1) An amount of 2250 g of γ-alumina particles (average particle diameter: 2 μm), 680 g of alumina fibers (average fiber diameter: 6 μm, average fiber length: 100 μm), and 2600 g of alumina sol (solid concentration: 30% by weight) were mixed together. To the resulting mixture were added 320 g of methylcellulose as an organic binder, 290 g of a lubricant (UNILUB, manufactured by NOF Corporation), and 225 g of a plasticizer (glycerin), and then further mixed and kneaded to obtain a mixed composition (a raw material composition). Next, the mixed composition was extrusion-molded by an extrusion-molding machine to provide a raw honeycomb molded body.

In this process, a raw honeycomb molded body having substantially the same shape with the center-portion honeycomb fired body 110 shown in FIG. 2, and a raw honeycomb molded body having substantially the same shape with the peripheral-portion honeycomb fired body 120 shown in FIG. 3 were manufactured.

(2) Next, the raw honeycomb molded bodies were sufficiently dried by using a microwave drying apparatus and a hot air drying apparatus, and then were allowed to stand at a temperature of 400° C. for two hours for degreasing.

(3) Thereafter, the degreased honeycomb molded bodies were allowed to stand at a temperature of 700 C for two hours so as to be fired, and thereby a center-portion honeycomb fired body 110, which was made of γ-alumina and had a size of 66.3 mm×66.3 mm×150 mm, the number of through holes (through hole density) of 93 pcs/cm² (600 cpsi) and a thickness of partition walls of 0.2 mm (8 mil) was manufactured. Also, a peripheral-portion honeycomb fired body 120, which had the same number of through holes (through hole density) and the same thickness of partition walls as those of the center-portion honeycomb fired body 110, and had a cross-sectional shape surrounded by three line segments and one arc, with two corners each formed by the two line segments out of these three line segments respectively having an angle of 90° and an angle of 135° (line segment 120a=30.9 mm, line segment 120b=66.9 mm and line segment 120c=59.0 mm) was manufactured.

Here, the cross-sectional area of the center-portion honeycomb fired body 110 was 4396 mm² and the cross-sectional area of the peripheral-portion honeycomb fired body 120 was 3971 mm². Therefore, the cross-sectional area of the peripheral-portion honeycomb fired body 120 was 0.9 times as large as the cross-sectional area of the center-portion honeycomb fired body 110.

(4) An adhesive paste was applied to predetermined side faces of the center-portion honeycomb fired body 110 and the peripheral-portion honeycomb fired body 120, and four pieces of the center-portion honeycomb fired bodies 110 and eight pieces of the peripheral-portion honeycomb fired bodies 120 were combined with one another with the adhesive paste interposed therebetween so as to be arranged into a layout shown in FIG. 1. The adhesive paste was solidified at 100° C. in 60 minutes to manufacture a round pillar-shaped ceramic block 103 having the adhesive layer 1 mm in thickness.

Here, an adhesive paste prepared by mixing 14.34 parts by weight of γ-alumina particles (average particle diameter: 2 μm), 16.37 parts by weight of alumina fibers (average fiber diameter: 6 μm, average fiber length: 100 μm), 17.35 parts by weight of an alumina sol (solid concentration: 30% by weight), 0.05 parts by weight of carboxymethyl cellulose (CMC), 0.98 parts by weight of polyvinyl alcohol (PVA), and 1.9 parts by weight of water was used as the adhesive paste.

(5) By using a coating material paste having the same composition as the adhesive paste used in the process (4), a coating material paste layer was formed on the peripheral portion of the ceramic block 103. Thereafter, the coating material paste layer was dried at 120° C. to manufacture a round pillar-shaped honeycomb structure 100 having a size of 254 mm in diameter×150 mm in length with a coat layer 102 formed on the periphery thereof.

(6) The honeycomb structure 100 manufactured in the above process (5) was immersed in an acetic acid solution containing 0.2 mol % of Ba(CO₃)₂ for one minute.

Thereafter, the honeycomb structure 100 was dried at a temperature of 600° C. for one hour so that the barium catalyst was supported on the honeycomb structure 100.

(7) Further, the honeycomb structure 100 was immersed in a solution (platinum solution) of diamine dinitro platinum nitric acid ([Pt(NH₃)₂(NO₂)₂]HNO₃, platinum concentration: 4.53% by weight) for one minute.

Thereafter, the honeycomb structure 100 was dried at 110° C. for two hours, and then fired at 500° C. for one hour in a nitrogen atmosphere so that the platinum catalyst was supported on the honeycomb structure 100.

The shape of a cross section of the honeycomb structure 100 manufactured in Example 1 was as shown in FIG. 4.

According to the honeycomb structure 100, in the cross section of the honeycomb structure 100, the first peripheral-portion adhesive layer 101C and the second peripheral-portion adhesive layer 101D form an angle of 45°.

Moreover, in the cross-section of the honeycomb structure 100, there exists a Y-shape portion formed by the first peripheral-portion adhesive layer 101C and the adhesive layers 101B each biding the center-portion honeycomb fired body 110 and the peripheral-portion honeycomb fired body 120.

### Examples 2 and 3, Comparative Examples 1 to 3

A honeycomb structure was manufactured in the same manner as Example 1, except that the size of the center-portion honeycomb fired body 110 (length of one side in the cross section) and the size of the peripheral-portion honeycomb fired body 120 (length of the line segment 120a, the line segment 120b, and the line segment 120c) were changed to the values described in Table 1.

Table 1 shows the length of one side of the center-portion honeycomb fired body 110, the length of each of the line segments of the peripheral-portion honeycomb fired body 120, the cross sectional area of the center-portion honeycomb fired body 110 and the peripheral-portion honeycomb fired body 120, and the ratio of the area of the peripheral-portion honeycomb fired body 120 to the area of the center-portion honeycomb fired body 110 (hereinafter, also simply referred to area ratio).

The diameter of each of the honeycomb structures manufactured in Examples and Comparative Examples is 254 mm.

### Comparative Example 4

(1) By performing the same procedures as the procedures (1) to (3) in Example 1, 16 pieces of honeycomb fired bodies which were similar to the center-portion honeycomb fired body 110 and had a size of 62.1 mm×62.1 mm×150 mm were manufactured.

(2) An adhesive paste was applied to predetermined side faces of the honeycomb fired bodies, and the 16 pieces of honeycomb fired bodies were combined with one another with the adhesive paste interposed therebetween. The adhesive paste was solidified at 180° C. for 20 minutes to manufacture an aggregated body of the honeycomb fired bodies having a rectangular pillar-shape, in which the thickness of the adhesive layers was 1 mm.

Here, as the adhesive paste, the same adhesive paste as the one used in Example 1 was used.

(3) Next, the aggregated body of the honeycomb fired bodies was cut by using a diamond cutter, to manufacture an almost round pillar-shaped ceramic block.

Subsequently, a coating material paste layer was formed on the peripheral portion of the ceramic block by using the coating material paste made of the same materials as those of the adhesive paste. Further, this coating material paste layer was dried at a temperature of 120° C. so that a round pillar-shaped honeycomb structure having a size of 254.0 mm in diameter×150.0 mm in length was manufactured.

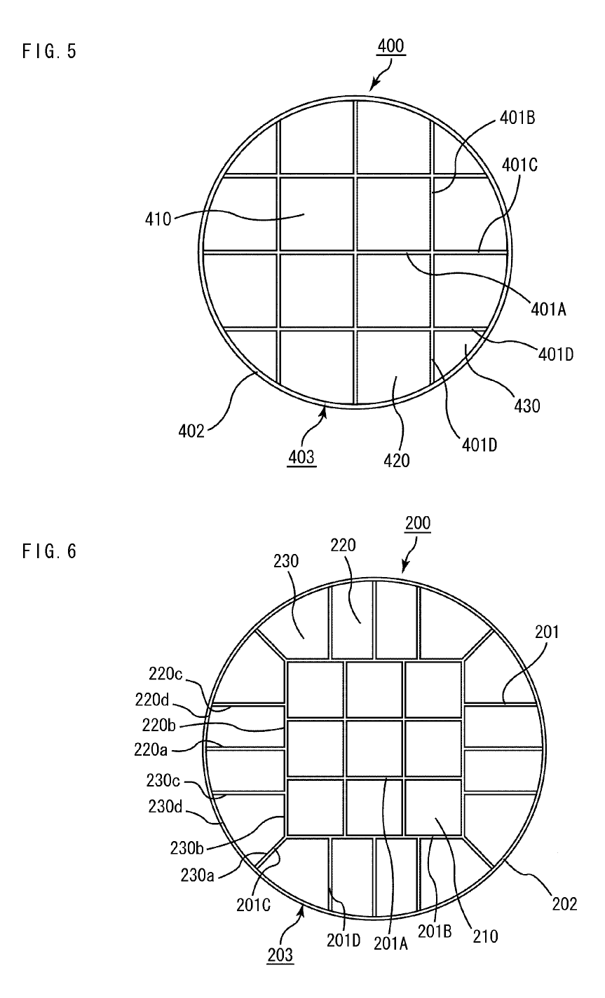

The cross-sectional shape of the honeycomb structure manufactured in Comparative Example 4 is shown in FIG. 5.

FIG. 5 is a cross-sectional view that shows the conventional honeycomb structure 400 manufactured in Comparative Example 4. In FIG. 5, a reference numeral 410 represents a center-portion honeycomb fired body, reference numerals 420 and 430 represent peripheral-portion honeycomb fired bodies, a reference numeral 401 (401A, 401B, 401C, 401D) represents an adhesive layer, a reference numeral 402 represents a coat layer and a reference numeral 403 represents a ceramic block.

In the cross section of the honeycomb structure 400, the first peripheral-portion adhesive layer 401C and the second peripheral-portion adhesive layer 401D are parallel or form an angle of 90°. Moreover, in the cross section of the honeycomb structure 400, there is no Y-shape portion formed by the adhesive layers.

In the honeycomb structure 400, the cross-sectional area of the center-portion honeycomb fired body 410 is 3856 mm², the cross-sectional area of the peripheral-portion honeycomb fired body 420 is 3548 mm², and the cross-sectional area of the peripheral-portion honeycomb fired body 430 is 1157 mm².

Therefore, the cross-sectional area of the peripheral-portion honeycomb fired body 420 is 0.9 times as large as the cross-sectional area of the center-portion honeycomb fired body 410, and the cross-sectional area of the peripheral-portion honeycomb fired body 430 is 0.3 times as large as the cross-sectional area of the center-portion honeycomb fired body 410.

The structures of the respective honeycomb structures manufactured according to Examples and Comparative Examples were collectively shown in Table 1.

### (Evaluation of Honeycomb Structure)

### (Measurement of Isostatic Fracture Strength)

According to “test method of ceramic monolith carrier for car exhaust gas purifying catalyst (JASO M 505-87)” specified in Japanese Automobile Standards Organization which is issued by Society of Automotive Engineers of Japan, measurement of isostatic fracture strength was performed on the honeycomb structures manufactured in each of Examples and Comparative Examples.

The test results are all shown in Table 1.

The contents of JASO M 505-87 are incorporated herein by reference in their entirety.

### (Thermal-Shock Test)

The honeycomb structures manufactured in respective Examples and Comparative Examples were heated by a heater until the temperature of the honeycomb structures increased to 700° C.

Thereafter, the honeycomb structures were cooled by flowing room-temperature air through the through holes. After the honeycomb structures were cooled to room temperature, presence of cracks was visually observed.

Table 1 shows the results of the thermal-shock test on each of the honeycomb structures manufactured in each of Examples and Comparative Examples. In Table 1, “absent” refers to a case in which no cracks were observed, and “present” refers to a case in which any crack was observed.

### (Evaluation of NOx Conversion Performance)

The honeycomb structure manufactured in each of Examples and Comparative Examples was connected to a 6-liter diesel engine.

Then, a cycle including flowing of simulated exhaust gases in a lean condition for 55 seconds and flowing of simulated exhaust gases in a rich condition for 5 seconds was repeatedly performed for 10 times.

During this operation, NO concentration was measured at the front and back of the honeycomb structure by using a NOx detection tube. The obtained NO concentrations in the whole operation time were integrated, and based on the difference between the integral NO concentration at the front of the honeycomb structure and the integral NO concentration at the back of the honeycomb structure, the NOx conversion rate was calculated according to the following equation.

NOx conversion rate (%)=[(N₀−N₁)/N₀]×100 (In the equation, N₀ indicates the NOx concentration before the gases pass through the honeycomb structure, and N₁ indicates the NOx concentration after the gases passed through the honeycomb structure.)

The measurement results of the NOx conversion rate of the honeycomb structures manufactured in Examples and Comparative Examples were collectively shown in Table 1.

TABLE 1

| | Area of | | | Size of | | | | Evaluation results | | |
|---|---|---|---|---|---|---|---|---|---|---|
| | honeycomb fired body (Note 1) | | | honeycomb fired body (mm) | | | | | | NOx |
| | Center | Peripheral | | | Peripheral | | | Isostatic | | conversion |
| | portion | portion | Area | Center- | portion | | | strength | Thermal-shock | rate |
| | (mm²) | (mm²) | ratio | portion | 120a | 120b | 120c | (MPa) | test | (%) |
| Example 1 | 4329 | 3971 | 0.9 | 66.3 | 30.9 | 66.9 | 59.0 | 2.1 | absent | 71 |
| Example 2 | 3856 | 4241 | 1.1 | 62.1 | 36.9 | 62.1 | 63.2 | 2.2 | absent | 73 |
| Example 3 | 3434 | 4454 | 1.3 | 58.6 | 41.8 | 58.6 | 66.7 | 2.1 | absent | 75 |
| Comparative | 4747 | 3794 | 0.8 | 68.9 | 27.2 | 68.9 | 56.4 | 1.8 | absent | 62 |
| Example 1 | | | | | | | | | | |
| Comparative | 3249 | 4547 | 1.4 | 57.0 | 44.1 | 57.0 | 68.3 | 1.9 | present | 75 |
| Example 2 | | | | | | | | | | |
| Comparative | 5013 | 3661 | 0.7 | 70.8 | 24.6 | 70.8 | 54.5 | 1.7 | present | 59 |
| Example 3 | | | | | | | | | | |
| Comparative | 3856 | 3548/1157 | 0.9/0.3 | 62.1 | — | — | — | 1.1 | absent | 55 |
| Example 4 | | | | | | | | | | |

(Note 1)
The data shown for Comparative Example 4 is area (ratio) of the peripheral-portion honeycomb fired body 420/area (ratio) of peripheral-portion honeycomb fired body 430.

As is clear from the results shown in Table 1, the honeycomb structures manufactured in Examples 1 to 3 had high isostatic fracture strength, had no occurrence of cracks caused by thermal-shock test, and had an excellent NOx conversion ability.

On the other hand, in the honeycomb structure manufactured in Comparative Example 1, the ratio of the area of the outer-portion honeycomb fired body to the area of the center-portion honeycomb fired body was as small as 0.8. Therefore, the heat capacity of the honeycomb structure was presumably high, and the NOx conversion rate was presumably small.

As for the honeycomb structure manufactured in Comparative Example 2, the above-mentioned area ratio was as high as 1.4, and thus cracks caused by thermal stress were presumably generated in the peripheral-portion honeycomb fired body during the thermal-shock test.

In the honeycomb structure manufactured in Comparative Example 3, the size of the center-portion honeycomb fired body was as large as 5013 mm², and the above-mentioned area ratio was as small as 0.7. Therefore, the honeycomb structure presumably had low isostatic fracture strength, and was easily damaged by thermal shock.

In the honeycomb structure manufactured in Comparative Example 4, since the adhesive layers were formed in a lattice pattern, the isostatic fracture strength was presumably low. Further, due to presence of the honeycomb fired body 430 in which the above-mentioned area ratio was as small as 0.3 in the peripheral portion, the honeycomb structure presumably had a high heat capacity and a low NOx conversion rate.

### Second Embodiment

Referring to Figures, the following description will discuss a second embodiment that is another embodiment of the honeycomb structure according to the embodiments of the present invention.

FIG. 6 is a cross-sectional view of a honeycomb structure according to the second embodiment.

As shown in FIG. 6, a honeycomb structure 200 of the present embodiment has a structure in which a plurality of center-portion honeycomb fired bodies 210 and pluralities of peripheral-portion honeycomb fired bodies 220 and 230 are combined with one another with adhesive layers 201A to 201D interposed therebetween so that a ceramic block 203 is formed. A coat layer 202 is formed on the periphery of the ceramic block 203.

The shape of the cross section of each of the center-portion honeycomb fired bodies 210 is a substantially square shape.

The cross section of each of the peripheral-portion honeycomb fired bodies 220 is formed into a shape that is surrounded by three line segments 220a, 220b and 220c and an arc 220d. Both of two angles made by two line segments out of these three line segments (an angle formed by the line segment 220a and the line segment 220b and an angle formed by the line segment 220b and the line segment 220c) are about 90°.

The cross section of each of the peripheral-portion honeycomb fired bodies 230 is formed into a shape that is surrounded by three line segments 230a, 230b and 230c and an arc 230d. The two angles made by two line segments out of these three line segments (an angle formed by the line segment 230b and the line segment 230c and an angle formed by the line segment 230a and the line segment 230b) are about 90° and about 135°, respectively.

Namely, the center-portion honeycomb fired body 210 is the same as the center-portion honeycomb fired body 110 forming the honeycomb structure of the first embodiment. The peripheral-portion honeycomb fired bodies 220 and 230 have the same functions as that of the center-portion honeycomb fired body 110 forming the honeycomb structure of the first embodiment although outside shapes of those peripheral-portion honeycomb fired bodies are different from that of the center-portion honeycomb fired body 110.

Moreover, the materials of the honeycomb fired bodies 210, 220, and 230 are the same as those of the center-portion honeycomb fired body 110 and the peripheral-portion honeycomb fired body 120 according to the first embodiment.

As shown in FIG. 6, in the honeycomb structure 200, nine pieces of center-portion honeycomb fired bodies 210 are located in the center portion of the cross section of the honeycomb structure 200, with eight pieces of peripheral-portion honeycomb fired bodies 220 and eight pieces of peripheral-portion honeycomb fired bodies 230 being located on the periphery of the nine pieces of center-portion honeycomb fired bodies 210. These honeycomb fired bodies are combined with one another with adhesive layers 201A to 201D interposed therebetween so that the cross section of the honeycomb structure 200 (ceramic block 203) is formed into a substantially round shape.

The nine pieces of the center-portion honeycomb fired bodies 210 combined with one another by interposing the adhesive layer 201A therebetween form the center portion in the cross-section of the honeycomb structure 200. The total 16 pieces of the peripheral-portion honeycomb fired bodies 220, 230 combined with one another by interposing the adhesive layers 201C, 201D form the peripheral portion in the cross section of the honeycomb structure 200.

In the cross section of the honeycomb structure 200 having the above-mentioned configuration, the region occupied by the nine pieces of the center-portion honeycomb fired bodies 210, the adhesive layer 201A combining the center-portion honeycomb fired bodies 210 with one another, the adhesive layer 201B combining the center-portion honeycomb fired body 210 with the peripheral-portion honeycomb fired bodies 220, 230 corresponds to the center portion, and the region occupied by the 16 pieces of the peripheral-portion honeycomb fired bodies 220, 230, and the adhesive layers 201C, 201D combining the peripheral-portion honeycomb fired bodies 220, 230 to each other corresponds to the peripheral portion.

Further, in the cross section of the honeycomb structure 200, the adhesive layer 201C (first peripheral-portion adhesive layer) that is formed in a direction from a corner points of the center portion to the peripheral side surface of the honeycomb structure 200 and the adhesive layer 201D (second peripheral-portion adhesive layer) that is formed in a direction from a point other than the corner points of the center portion to the peripheral side surface of the honeycomb structure 200, among the adhesive layers 201C, 201D in the peripheral portion, form an angle of about 45°.

When the first peripheral-portion adhesive layer and the second peripheral-portion adhesive layer form an angle of about 45° as mentioned above, it is easier to prevent damages from occurring in the honeycomb structure.

Moreover, in the honeycomb structure 200, at the corner point of the above-mentioned center portion, the first peripheral-portion adhesive layer 201C and two adhesive layers 201B combining the center-portion honeycomb fired body 210 with the peripheral-portion honeycomb fired body 220 form a Y-shape.

When there is a portion where the adhesive layers form a Y-shape in a cross-section of the honeycomb structure as mentioned above, such a configuration is suitable for reducing the stress in the honeycomb structure, and thus it is easier to prevent damages from occurring in the honeycomb structure.

Here, in the honeycomb structure 200, the cross-sectional area of the center-portion honeycomb fired body 210 is at least about 2500 mm² and at most about 5000 mm². The cross-sectional area of the peripheral-portion honeycomb fired bodies 220, 230 is at least about 0.9 times and at most about 1.3 times as large as that of the cross-sectional area of the center-portion honeycomb fired body 210.

Therefore, no honeycomb fired bodies having an extremely small cross-sectional area are located in the peripheral portion of the honeycomb structure 200, and of course, an adhesive layer to be used for combining such small honeycomb fired bodies to one another is not required. For this reason, the honeycomb structure 200 is less likely to have a temperature distribution between the center portion and the peripheral portion.

The following description will discuss a method for manufacturing the honeycomb structure of the present embodiment.

The method for manufacturing the honeycomb structure of the present embodiment is the same as the method for manufacturing the honeycomb structure of the first embodiment, except for the following points.

That is, the honeycomb structure of the present embodiment can be manufactured by using the same method as the method for manufacturing the honeycomb structure of the first embodiment, except that the shapes of honeycomb molded bodies formed in the molding process of the manufacturing method according to the first embodiment have substantially the same shapes as those of the center-portion honeycomb fired body 210 and the peripheral-portion honeycomb fired bodies 220 and 230 as shown in FIG. 6, and except that, upon carrying out the combining process of the manufacturing method of the first embodiment, the respective honeycomb fired bodies are combined with one another so that the center-portion honeycomb fired body 210 and the peripheral-portion honeycomb fired bodies 220 and 230 are located as shown in FIG. 6.

The honeycomb structure of the present embodiment is allowed to exert the same effects as those of the honeycomb structure of the first embodiment.

### Other Embodiments

In the methods for manufacturing a honeycomb structure according to the first and second embodiments, a honeycomb structure is manufactured by forming a honeycomb fired body prepared in a predetermined shape. However, the honeycomb structure according to an embodiment of the present invention may be manufactured according to the method described below.

Hereinafter, another method for manufacturing a honeycomb structure according to an embodiment of the present invention will be described by exemplifying the case of manufacturing the honeycomb structure according to the first embodiment.

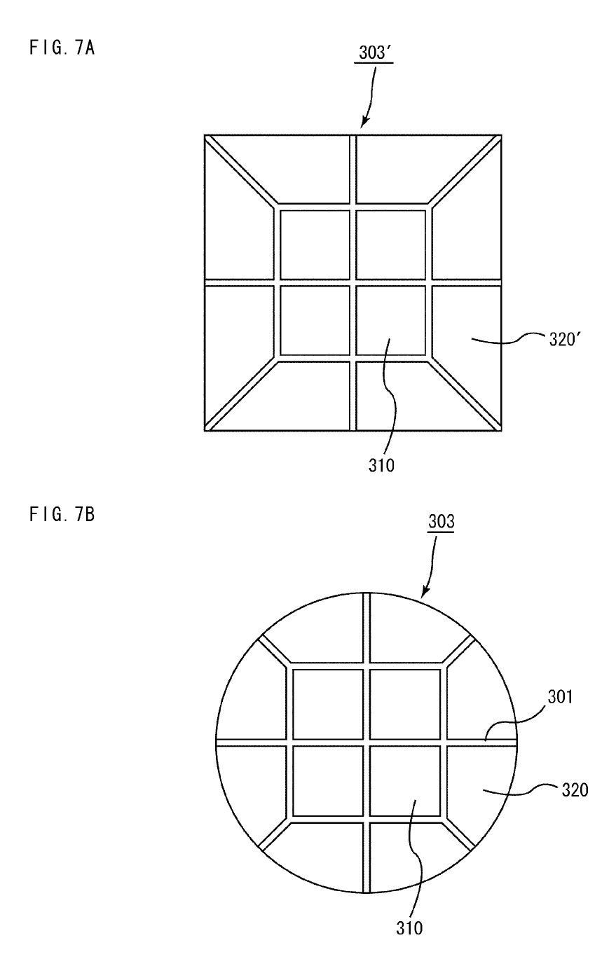

FIGS. 7A and 7B are cross-sectional views for describing another example of a method for manufacturing a honeycomb structure according to an embodiment of the present invention.

(1) A honeycomb fired body is manufactured by the same method as the method in the first embodiment.

In this example, a center-portion honeycomb fired body 310 having a square cross-sectional shape and a peripheral-portion honeycomb fired body 320′ having a trapezoid cross-sectional shape are manufactured (see FIG. 7A).

(2) Next, in the same manner as in the process (4) of the first embodiment, the center-portion honeycomb fired bodies 310 and the peripheral-portion honeycomb fired bodies 320′ are combined with one another with the adhesive paste layer interposed therebetween so as to be arranged into a layout shown in FIG. 7A. Moreover, an aggregated body 303′ of honeycomb fired bodies is manufactured by solidifying the adhesive paste layer (see FIG. 7A).

(3) Next, a peripheral cutting process is performed in which the side faces of the aggregated body 303′ of honeycomb fired bodies are cut by using a diamond cutter or the like to form a substantially round pillar shape so as to manufacture a ceramic block 303 in which the center-portion honeycomb fired bodies 310 and the peripheral-portion honeycomb fired bodies 320 are combined with one another with the adhesive layer 301 interposed therebetween (see FIG. 7B).

Then, if needed, a coat layer (not illustrated) is formed on the peripheral side face of the ceramic block 303 to complete a honeycomb structure.

The cross-sectional shape of the honeycomb structure according to the embodiments of the present invention is not limited to a substantially round shape. The cross-sectional shape may be a substantially elliptical shape, a substantially elongated round shape (substantially racetrack shape) or the like.

Moreover, in the honeycomb structure according to the embodiments of the present invention, the number of the center-portion honeycomb fired body is not limited to plural, and may be one.

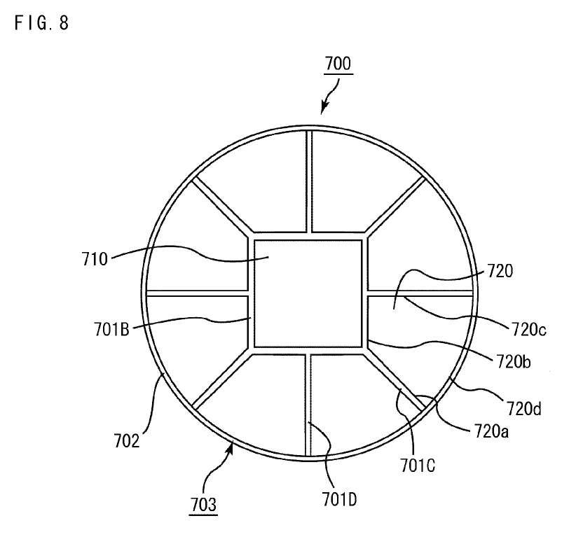

Specifically, the shape of a cross section of the honeycomb structure may be a shape shown in FIG. 8.

FIG. 8 is a cross-sectional view of a honeycomb structure according to another embodiment of the present invention.

The honeycomb structure 700 as illustrated in FIG. 8 has the same structure as that of the honeycomb structure 100 of the first embodiment, except that the number of the center-portion honeycomb fired bodies is different.

That is, the honeycomb structure 700 as illustrated in FIG. 8 includes one center-portion honeycomb fired body 710, instead of the four pieces of the center-portion honeycomb fired bodies 110 combined with one another with the adhesive layer 101A interposed therebetween in the honeycomb structure 100 as illustrated in FIG. 1.

Compared with the center-portion honeycomb fired body 110, the center-portion honeycomb fired body 710 has a larger cross-sectional area but has the same functions.

In the cross-section of the honeycomb structure 700 of this kind, the first peripheral-portion adhesive layer 701C and the second peripheral-portion adhesive layer 701D form an angle of about 45°.

Further, in the honeycomb structure 700, the first peripheral-portion adhesive layer 701C and two adhesive layers 701B combining the center-portion honeycomb fired body 710 with the peripheral-portion honeycomb fired body 720 form a Y-shape at a corner point of the center portion.

Therefore, the honeycomb structure 700 can exert the same effects as the effects described in the first embodiment.

Here, in FIG. 8, the numeral 702 represents a coat layer, and the numeral 703 represents a ceramic block.

In the cross section of the honeycomb structure according to the embodiment of the present invention, the angle formed by the first peripheral-portion adhesive layer and the second peripheral portion adhesive layer is not limited to about 45°, and may be an angle of at least about 40° and at most about 50°.

This is because, the angle formed by the first peripheral-portion adhesive layer and the second peripheral-portion adhesive layer within the above range is appropriate for preventing damages due to stress generated in various directions on the peripheral surface of the honeycomb structure.

Although, all the angles formed by the first peripheral-portion adhesive layer and the second peripheral-portion adhesive layer are angles of at least about 40° and at most about 50° in the honeycomb structure of the embodiment described above, the angles may be any angle as long as at least one angle formed by one of the first peripheral-portion adhesive layer and one of the second peripheral-portion adhesive layer is at least about 40° and at most about 50°.

The thickness of the partition wall of the honeycomb fired body is not particularly limited, and the preferable lower limit is about 0.05 mm, more preferable lower limit is about 0.10 mm, and still more preferable lower limit is about 0.15 mm. On the other hand, the preferable upper limit is about 0.40 mm, and more preferable upper limit is about 0.35 mm.

The partition wall having a thickness of about 0.05 mm or more is less likely to reduce the strength of the honeycomb fired body, while the partition wall having a thickness of about 0.40 mm or less is less likely to reduce areas to contact to exhaust gases and is more likely to allow the exhaust gases to deeply penetrate the partition wall. Therefore, contact between exhaust gases and the catalyst supported inside the partition wall becomes easier, and thus the catalytic effect is less likely to be reduced.

Moreover, the preferable lower limit of the density of the through holes in the honeycomb fired body is about 15.5 pcs/cm² (about 100 cpsi), and more preferable lower limit is about 46.5 pcs/cm² (about 300 cpsi), and still more preferable lower limit is about 62.0 pcs/cm² (about 400 cpsi). On the other hand, the preferable upper limit of the density of the through holes is about 186 pcs/cm² (about 1200 cpsi), and more preferable lower upper limit is about 170.5 pcs/cm² (about 1100 cpsi), and still more preferable upper limit is about 155 pcs/cm² (about 1000 cpsi).

This is because, the through hole density of about 15.5 pcs/cm² or more is less likely to reduce the area of walls to contact to exhaust gases inside the honeycomb fired body, while the through hole density of about 186 pcs/cm² or less is less likely to cause an increase of pressure loss and to make production of the honeycomb fired body difficult.

The thickness of the adhesive layer of the honeycomb fired body is not particularly limited, and the preferable thickness is at least about 0.5 mm and at most about 5.0 mm.

This is because, the adhesive layer having a thickness of about 0.5 mm or more is more likely to have a sufficient combining strength. On the other hand, since the adhesive layer is a portion that is not functioning as catalyst carrier, the adhesive layer having a thickness of about 5 mm or less is less likely to reduce the specific surface per unit volume of the honeycomb structure. Therefore, when the honeycomb structure is used as a catalyst carrier for converting exhaust gases, sufficiently high dispersion of the catalyst is more likely to be achieved.

Further, the adhesive layer having a thickness of about 5 mm or less is less likely to cause increase of pressure loss.

The thickness of the coat layer is not particularly limited, and the preferable thickness is at least about 0.1 mm and at most about 2 mm. The coat layer having a thickness of about 0.1 mm or more is more likely to sufficiently protect the peripheral surface, and thus the strength is more likely to be improved. On the other hand, the coat layer having a thickness of about 2 mm or less is less likely to reduce the specific area per unit volume in the honeycomb structure. Therefore, when the honeycomb structure is used as a catalyst carrier for converting exhaust gases, sufficiently high dispersion of the catalyst is more likely to be achieved.

In the combining process in the method for manufacturing the honeycomb structure of each embodiment of the present invention, instead of the method in which an adhesive paste is applied to side faces of each honeycomb fired body, for example, another method may be used in which, with respective honeycomb fired bodies temporarily secured in a frame having substantially the same shape as the shape of a ceramic block (or an aggregated body of honeycomb fired bodies) to be manufactured, an adhesive paste is injected between the respective honeycomb fired bodies.

The plasticizer contained in the raw material composition is not particularly limited, and an example thereof is glycerin, and the like. The lubricant is not particularly limited, and examples thereof include polyoxyalkylene compounds such as polyoxyethylene alkyl ether, polyoxypropylene alkyl ether, and the like.

Specific examples of the lubricant include polyoxyethylene monobutyl ether, polyoxypropylene monobutyl ether, and the like.

Also, in some cases, the plasticizer or lubricant may not be contained in the raw material composition.

The diffusion medium contained in the raw material composition is not particularly limited, and examples thereof include water, an organic solvent (e.g. benzene), an alcohol (e.g. methanol), and the like.

The molding auxiliary is not particularly limited, and examples thereof include ethylene glycol, dextrin, fatty acids, fatty acid soap, polyalcohol, and the like.

Obviously, numerous modifications and variations of the present invention are possible in light of the above teachings. It is therefore to be understood that within the scope of the appended claims, the invention may be practiced otherwise than as specifically described herein.

What is claimed as new and desired to be secured by Letters Patent of the United States is:

1. A honeycomb structure comprising:
a plurality of honeycomb fired bodies combined with one another by interposing an adhesive layer therebetween, each of the honeycomb fired bodies having partition walls extending along a longitudinal direction of the honeycomb structure to define through holes and comprising inorganic particles and an inorganic binder, said honeycomb fired bodies comprising:
a center-portion honeycomb fired body located in a center portion in a cross section perpendicular to the longitudinal direction, the center-portion honeycomb fired body having a substantially rectangular cross-sectional shape perpendicular to the longitudinal direction and having an area from about 2500 mm² to about 5000 mm² in the cross-section; and
a peripheral-portion honeycomb fired body located in a peripheral portion in the cross section, a cross-sectional shape of the peripheral-portion honeycomb fired body perpendicular to the longitudinal direction being different from the cross-sectional shape of the center-portion honeycomb fired body, a cross-sectional area of said peripheral-portion honeycomb fired body perpendicular to the longitudinal direction being from about 0.9 times to about 1.3 times as large as the cross-sectional area of said center-portion honeycomb fired body.

2. The honeycomb structure according to claim 1,
wherein
a cross section perpendicular to said longitudinal direction includes a peripheral portion forming a peripheral side surface of said honeycomb structure and a center portion having a substantially rectangular cross-sectional shape located at an inner side of said peripheral portion,
said peripheral portion comprises a plurality of said peripheral-portion honeycomb fired bodies combined with one another by interposing said adhesive layer therebetween,
said center portion comprises a single piece of said center-portion honeycomb fired body, or a plurality of said center-portion honeycomb fired bodies combined with one another by interposing said adhesive layer therebetween,
a cross section perpendicular to said longitudinal direction includes at least one adhesive layer, among the adhesive layers in said peripheral portion, formed in a direction extending from a corner point of said center portion to the peripheral side surface of said honeycomb structure, and
said adhesive layer extending from the corner point of said center portion to the peripheral side surface of said honeycomb structure forms an angle of from about 40 degrees to about 50 degrees with at least one adhesive layer formed in a direction extending from a point other than the corner points of the center portion to the peripheral side surface of said honeycomb structure.

3. The honeycomb structure according to claim 1, comprising a plurality of said center-portion honeycomb fired bodies and a plurality of said peripheral-portion honeycomb fired bodies,
wherein
the cross-sectional surface areas of the plurality of the center-portion honeycomb fired bodies are substantially same with each other, and
the cross-sectional surface areas of the plurality of the peripheral-portion honeycomb fired bodies are substantially same with each other.

4. The honeycomb structure according to claim 1,
wherein
the cross-sectional shape of said peripheral-portion honeycomb fired body perpendicular to said longitudinal direction is formed into a shape surrounded by three line segments and one curved line, and
two angles made by two line segments out of said three line segments are a substantially right angle and an obtuse angle.

5. The honeycomb structure according to claim 1, further comprising an inorganic fiber.

6. The honeycomb structure according to claim 5,
wherein
said inorganic fiber comprises at least one of alumina, silica, silicon carbide, silica-alumina, glass, potassium titanate, and aluminum borate.

7. The honeycomb structure according to claim 1,
wherein
a catalyst is supported on said partition wall.

8. The honeycomb structure according to claim 7,
wherein
said catalyst comprises at least one of a noble metal, an alkali metal, and an alkaline earth metal.

9. The honeycomb structure according to claim 8,
wherein
said noble metal comprises at least one of platinum, palladium, and rhodium.

10. The honeycomb structure according to claim 8,
wherein
said alkali metal comprises at least one of potassium and sodium.

11. The honeycomb structure according to claim 8,
wherein
said alkaline earth metal comprises at least one of magnesium, barium, and calcium.

12. The honeycomb structure according to claim 1,
wherein
said inorganic particles are at least one of alumina, silica, zirconia, titania, ceria, mullite and zeolite.

13. The honeycomb structure according to claim 1,
wherein
said inorganic binder is at least one of an inorganic sol and a clay binder.

14. The honeycomb structure according to claim 1,
wherein
said inorganic binder comprises at least one of alumina sol, silica sol, titania sol, water glass, sepiolite, and attapulgite.

15. A method for manufacturing a honeycomb structure, comprising:
extrusion-molding a raw material composition containing inorganic particles and an inorganic binder to produce a center-portion honeycomb molded body to be a center-portion honeycomb fired body and a peripheral-portion honeycomb molded body to be a peripheral-portion honeycomb fired body, the center-portion honeycomb molded body having substantially a same shape as the center-portion honeycomb fired body, each of the center-portion and the peripheral-portion honeycomb fired bodies having partition walls extending along a longitudinal direction of the honeycomb structure to define through holes;
heating the center-portion honeycomb molded body and the peripheral-portion honeycomb molded body in a degreasing furnace to remove organic components contained in the center-portion honeycomb molded body and the peripheral-portion honeycomb molded body and to degrease the center-portion honeycomb molded body and the peripheral-portion honeycomb molded body;
firing the degreased center-portion honeycomb molded body and the degreased peripheral-portion honeycomb molded body to produce the center-portion honeycomb fired body and the peripheral-portion honeycomb fired body, the center-portion honeycomb fired body having a substantially rectangular cross-sectional shape perpendicular to the longitudinal direction, the center-portion honeycomb fired body having an area from about 2500 mm² to about 5000 mm² in the cross-section, a cross-sectional shape of the peripheral-portion honeycomb fired body perpendicular to the longitudinal direction being different from a cross-sectional shape of the center-portion honeycomb fired body perpendicular to the longitudinal direction, a cross-sectional area of the peripheral-portion honeycomb fired body perpendicular to the longitudinal direction being from about 0.9 times to about 1.3 times as large as a cross-sectional area of the center-portion honeycomb fired body perpendicular to the longitudinal direction; and
combining a predetermined number of honeycomb fired bodies by interposing an adhesive layer therebetween so that the peripheral-portion honeycomb fired bodies are located around the center-portion honeycomb fired body to produce a ceramic block.

16. The method for manufacturing a honeycomb structure according to claim 15,
wherein
the peripheral-portion honeycomb molded body has a shape different from the center-portion honeycomb fired body in a cross section perpendicular to the longitudinal direction, and
the peripheral-portion honeycomb molded body has an area of from about 0.9 times to about 1.3 times as large as the area of the center-portion honeycomb fired body in the cross section perpendicular to the longitudinal direction.

17. The method for manufacturing a honeycomb structure according to claim 15,
wherein
an aggregated body of the honeycomb fired bodies is produced by combining said center-portion honeycomb fired body and said peripheral-portion honeycomb fired body by interposing an adhesive layer, and
said ceramic block is produced by cutting a side face of said aggregated body of the honeycomb fired bodies so that
said cross-sectional shape perpendicular to said longitudinal direction of said peripheral-portion honeycomb fired body is different from the cross-sectional shape perpendicular to said longitudinal direction of said center-portion honeycomb fired body, and
said cross-sectional area perpendicular to said longitudinal direction of said peripheral-portion honeycomb fired body is from about 0.9 times to about 1.3 times as large as said cross-sectional area of said center-portion honeycomb fired body.

18. The method for manufacturing a honeycomb structure according to claim 15,
wherein
the cross section perpendicular to said longitudinal direction includes a peripheral portion forming a peripheral side surface of said honeycomb structure and a center portion having a substantially rectangular cross-sectional shape located at an inner side of said peripheral portion,
said peripheral portion comprises a plurality of said peripheral-portion honeycomb fired bodies combined with one another by interposing said adhesive layer therebetween,
said center portion comprises a single piece of said center-portion honeycomb fired body, or a plurality of said center-portion honeycomb fired bodies combined with one another by interposing said adhesive layer therebetween,
the cross section perpendicular to said longitudinal direction includes at least one adhesive layer, among the adhesive layers in said peripheral portion, formed in a direction extending from a corner point of said center portion to the peripheral side surface of said honeycomb structure, and
said adhesive layer extending from the corner point of said center portion to the peripheral side surface of said honeycomb structure forms an angle of from about 40 degrees to about 50 degrees with at least one adhesive layer formed in a direction extending from a point other than the corner points of said center portion to the peripheral side surface of said honeycomb structure.

19. The method for manufacturing a honeycomb structure according to claim 15,
wherein
said honeycomb structure comprises a plurality of said center-portion honeycomb fired bodies and a plurality of said peripheral-portion honeycomb fired bodies,
the cross-sectional surface areas of said plurality of said center-portion honeycomb fired bodies are substantially same with each other, and
the cross-sectional surface areas of said plurality of said peripheral-portion honeycomb fired bodies are substantially same with each other.

20. The method for manufacturing a honeycomb structure according to claim 15,
wherein
the cross-sectional shape of said peripheral-portion honeycomb fired body perpendicular to said longitudinal direction in said honeycomb structure is formed into a shape surrounded by three line segments and one curved line, and
two angles made by two line segments out of said three line segments are a substantially right angle and an obtuse angle.

21. The method for manufacturing a honeycomb structure according to claim 15,
wherein
said raw material composition further comprises an inorganic fiber.

22. The method for manufacturing a honeycomb structure according to claim 21,
wherein
said inorganic fiber comprises at least one of alumina, silica, silicon carbide, silica-alumina, glass, potassium titanate, and aluminum borate.

23. The method for manufacturing a honeycomb structure according to claim 15, said method further comprising
supporting a catalyst on said honeycomb structure.

24. The method for manufacturing a honeycomb structure according to claim 23,
wherein
said catalyst comprises at least one of a noble metal, an alkali metal, and an alkaline earth metal.

25. The method for manufacturing a honeycomb structure according to claim 24,
wherein
said noble metal comprises at least one of platinum, palladium, and rhodium.

26. The method for manufacturing a honeycomb structure according to claim 24,
wherein
said alkali metal comprises at least one of potassium and sodium.

27. The method for manufacturing a honeycomb structure according to claim 24,
wherein
said alkaline earth metal comprises at least one of magnesium, barium, and calcium.

28. The method for manufacturing a honeycomb structure according to claim 15,
wherein
said inorganic particles are at least one of alumina, silica, zirconia, titania, ceria, mullite and zeolite.

29. The method for manufacturing a honeycomb structure according to claim 15,
wherein
said inorganic binder is at least one of an inorganic sol and a clay binder.

30. The method for manufacturing a honeycomb structure according to claim 15,
wherein
said inorganic binder comprises at least one of alumina sol, silica sol, titania sol, water glass, sepiolite, and attapulgite.

31. The method for manufacturing a honeycomb structure according to claim 15, said method further comprising
forming a coat layer by applying a coating material paste on the periphery of said ceramic block, and then drying and solidifying the coating material paste.
